(19) United States
(12) Patent Application Publication
(10) Pub. No.: US 2010/0262437 A1
(43) Pub. Date: Oct. 14, 2010

(54) SYSTEM AND METHOD FOR ADMINISTERING INCOME REPLACEMENT AND LONGEVITY INSURANCE

(75) Inventor: Michael Roscoe, South Windsor, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/421,353

(22) Filed: Apr. 9, 2009

(51) Int. Cl. G06Q 40/00

(52) U.S. Cl. 705/4

(57) ABSTRACT

A computer system for administering an insurance account for providing income replacement and longevity insurance for a primary wage earner and a beneficiary has a processor and a memory storage device in communication with the processor. The processor is adapted to access data indicative of whether the account is in an income replacement phase, an intermediate phase or a longevity phase. The processor is adapted to, if the primary wage earner is deceased and the beneficiary is not deceased, and the account is in the income replacement phase, output a signal having data indicative of one or more payments to the beneficiary. The processor is also adapted to, if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

### FIELD OF INVENTION

The present invention relates to computer systems, and particularly to computer systems for calculating features of financial products.

### BACKGROUND

In financial plans for couples seeking to save for retirement, the plan typically provides for the couple to contribute to retirement savings on a periodic basis while the couple is employed and receiving income from employment. For example, contributions from each pay period, quarterly, or annually may be called for by the plan. The financial plan typically makes assumptions relating to investment growth that provide for a particular sum to be accumulated between the contributions and the growth in invested contributions at the time of retirement. For example, at a planned retirement age, such as 65, a certain sum is expected in accordance with the plan. The plan provides for withdrawals from the sum of retirement savings for a period of years, given typical life expectancy assumptions.

### SUMMARY

In one embodiment, a computer system for administering an insurance account for providing income replacement and longevity insurance for a primary wage earner and a beneficiary has a processor and a memory storage device in communication with the processor. The processor is adapted to: access from the memory storage device data indicative of whether the account is in an income replacement phase, an intermediate phase commencing at the end of the income replacement phase, or a longevity phase commencing at the end of the income replacement phase; access data indicative of whether the primary wage earner and the beneficiary are deceased; if the primary wage earner is not deceased and the account is in the income replacement phase or the intermediate phase, access data indicative of whether account communication is due, and based on the data indicative of account communication, provide account communication, or take no further action; if the primary wage earner is deceased and the beneficiary is not deceased, and the account is in the income replacement phase, access data indicative of a schedule of periodic payments, including dates and amounts of payments, to the beneficiary for a term continuing until a predetermined age of the primary wage earner; output a signal indicative of the schedule of periodic payments; if the account is in the intermediate phase, provide an output signal indicating that no action will be taken in response to the death of the deceased; if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

In an embodiment, a computer system for administering an insurance account for providing income replacement and longevity insurance for a primary wage earner and a beneficiary has a processor and a memory storage device in communication with the processor. The processor is adapted to: access data indicative of whether the account is in an income replacement phase, an intermediate phase commencing at the end of the income replacement phase, or a longevity phase commencing at the end of the intermediate phase; access data indicative of whether the primary wage earner and the beneficiary are deceased; if the primary wage earner is deceased and the beneficiary is not deceased, and the account is in the income replacement phase, access data indicative of one or more payments to the beneficiary; output a signal having data indicative of the one or more payments to the beneficiary; if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

In an embodiment, a system for determining an insurance plan having income replacement and longevity protection features for supplementing a financial plan for retirement income for a couple having one primary wage earner has a processor and a memory device in communication with the processor. The processor is adapted to: receive data relating to the financial plan, the data including: amount and timing of periodic payments to a retirement fund funded by wages of one of the couple; investment return assumptions for the retirement fund; and retirement income assumptions including periodic payments and a date of cessation of payments; current ages of the individuals of the couple; and separate contributions of the individuals of the couple to the retirement account; determine at least a cost of an insurance account for providing the periodic payments to the retirement fund in the event of the death of one of the couple and income in the event of survival of at least one of the couple past the date of cessation of payments.

In an embodiment, a computer-implemented method for administering an insurance account for providing income replacement and longevity insurance for a primary wage earner and a beneficiary includes accessing by a processor from a memory storage device data indicative of whether the account is in an income replacement phase, an intermediate phase commencing at the end of the income replacement phase, or a longevity phase commencing at the end of the intermediate phase; accessing by the processor from a memory storage device data indicative of whether the primary wage earner and the beneficiary are deceased; if the primary wage earner is deceased and the beneficiary is not deceased, and the account is in the income replacement phase, accessing by the processor data indicative of amounts and timing of payments to the beneficiary; providing by the processor an output signal having data indicative of the payments to the beneficiary; if the account is in the longevity phase, and either of the primary wage earner or the beneficiary are not deceased, accessing by the processor data indicative of a schedule of periodic payments, including dates and amounts of payments, to at least one of the primary wage earner and the beneficiary for a term continuing until the last to die of the beneficiary and the primary wage earner.

In an embodiment, a method for determining features of an insurance plan having income replacement and longevity protection features for supplementing a financial plan for retirement income for a couple having a primary wage earner, includes receiving by the processor data relating to the financial plan, said data including: amount and timing of periodic payments to a retirement fund funded by wages of one of the couple; investment return assumptions for the retirement fund; and retirement income assumptions including periodic payments and a date of cessation of payments; current ages of the individuals of the couple; and separate contributions of the individuals of the couple to the retirement account; determining by the processor at least a cost of an insurance account for providing the periodic payments to the retirement fund in the event of the death of one of the couple and income in the event of survival of at least one of the couple past the date of cessation of payments.

In an embodiment, a computer-readable medium having a plurality of instructions thereon which, when executed by a processor, cause the processor to: access data indicative of whether the account is in an income replacement phase, an intermediate phase commencing at the end of the income replacement phase, or a longevity phase commencing at the end of the intermediate phase; access data indicative of whether the primary wage earner and the beneficiary are deceased; if the account is in any of the phases and both the primary wage earner and the beneficiary are deceased, output a signal having data indicative that the account is closed; if the primary wage earner is deceased and the beneficiary is not deceased, and the account is in the income replacement phase, access data indicative of one or more payments to the beneficiary, and output a signal having data indicative of the one or more payments to the beneficiary; if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

### BRIEF DESCRIPTION OF THE FIGURES

FIG. 1 is a schematic diagram of an exemplary computer system for implementation of a method and system of the invention.

FIG. 2 is a schematic diagram of an exemplary network for implementation of a method and system of the invention.

FIG. 3 is a schematic diagram showing the computer system of FIG. 1 and payment systems.

FIG. 4 is a process flow diagram illustrating a method for determining features of an insurance account and implemented by the computer system of FIG. 1.

FIG. 5 is a schematic illustration of a retirement plan and an insurance account.

FIG. 6 is a schematic illustration of a retirement plan showing benefit payments from the insurance account.

FIG. 7 is a schematic illustration of a retirement plan and insurance account showing benefits payable for long term care.

FIG. 8 is a process flow diagram of an embodiment of a method of administering an insurance account providing income replacement and longevity protection.

FIG. 9 is a process flow diagram of an embodiment of a method of illustrating features of an insurance account providing income replacement and longevity protection.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for administration of insurance accounts and insurance products such as income replacement products and annuities. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge recognized by the inventor in connection with financial plans is that all or most of the contributions to the retirement plan may be expected to come from the earnings of one member of the couple. For example, only one member of the couple may earn wages, or while both earn wages, there may be a substantial disparity between the earnings of the members of the couple. If the higher-earning member of the couple dies or is disabled prior to retirement, the sum at retirement may not be sufficient for the anticipated standard of living during retirement of either both or the surviving member of the couple. A further challenge recognized by the inventor is maintaining income if one or both members of the couple live longer than anticipated by the retirement plan.

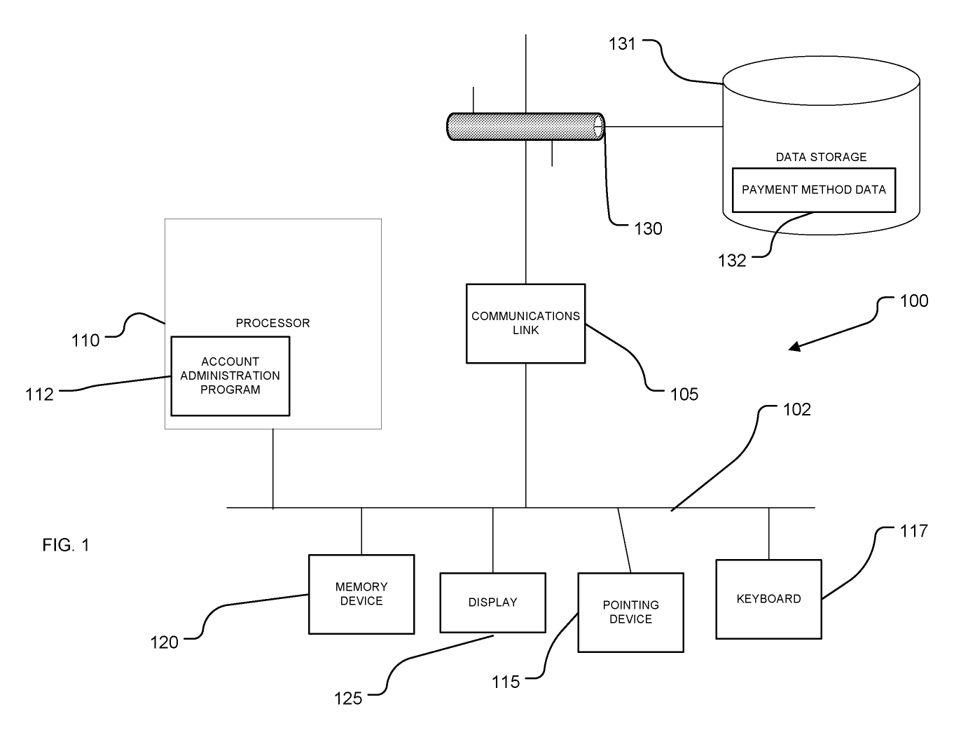

Referring to FIG. 1, an exemplary computer system 100 for use in an implementation of the invention will now be described. In computer system 100, processor 110 executes instructions contained in programs such as account administration program 112. Programs may be stored on suitable media, such as optical or magnetic disks, fixed disks with magnetic storage (hard drives), tapes accessed by tape drives, and other storage media. Processor 110 communicates, such as through bus 102 and/or other data channels, with communications port 105 and memory device 120, receives data from user inputs 115, and provides data to outputs 125. Memory device 120 is configured to exchange data with processor 110, and may store programs containing processor-executable instructions, and values of variables for use by such programs. User input may be provided at inputs 115, which may include keyboards, pointing devices such as mice, and touch screens. In an embodiment, inputs 115 may include user interfaces, including workstations having keyboards, touch screens, pointing devices such as mice, or other user input devices, connected via networked communications to processor 110. Outputs 125 may include displays and printers. Communications link 105 may communicate with remote sources of information, and with systems for implementing instructions output by processor 110, via LAN 130. LAN 130 is merely exemplary, and communication may be by one or more of suitable communication methods, including over wired or wireless local area networks and wide area networks, and over communications between networks, including over the Internet. Any suitable data and communication protocols may be employed. Data storage 131, which may include a wide variety of data acquired and processed in accordance with embodiments, is accessed via LAN 130. Data storage 131 may include payment method data 132, by way of example.

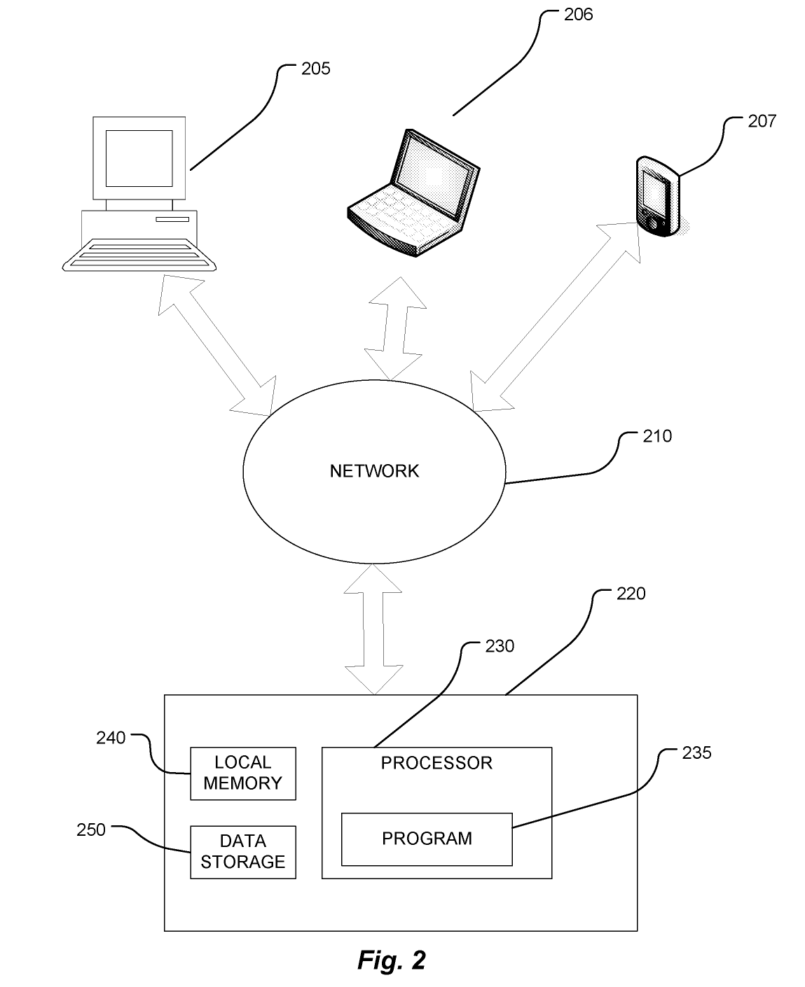

Referring now to FIG. 2, a schematic diagram of a client server arrangement for implementation of a method and system in accordance with an embodiment of the invention is presented. In the arrangement of FIG. 2, client devices 205, 206, 207 may be connected via network 210 to server 220. In an implementation, client devices 205, 206, 207 may be personal computers running an operating system such as Windows XP, Windows Vista, or Apple Tiger, thin client devices, portable devices such as personal digital assistants (running the Palm OS, by way of example), cell phones, or other devices. Client devices may be operated variously by individual prospective annuitants, insurance brokers or other financial advisors, or by personnel of an insurance service provider. Network 210 may be or include the Internet, a corporate intranet, wireless and wired communications channels, and other network features. Server 220 may include processor 230 having local memory 240 and data storage 250. Illustration program 235 runs on processor 230. Program 235 may initiate sessions with one more of client devices 205, 206, 207. Program 235 may cause server 220 to serve for display on client devices 205, 206, 207, prompts to the user for information regarding financial plan data, amount and timing of periodic payments to a retirement fund funded by wages of one of the primary wage earner; investment return assumptions for the retirement fund; and retirement income assumptions including periodic payments and a date of cessation of payments; current ages of the individuals of the couple; and separate contributions of the individuals of the couple to the retirement account. The prompts may include a prompt to provide a retirement income periodic payment amount for use in determining benefits in the event of the death of one of the couple.

Program 235 may include instructions causing processor 230 to determine features, such as premiums, of an insurance account to provide income replacement and longevity protection, and to format and serve to client devices 205, 206, 207 illustrations of such insurance accounts. Program 235 may include instructions causing processor 230 to display prompts to permit a user to change retirement plan data in association with an illustration, such as on the same screen as an illustration, via a link on the screen displaying the illustration to one or more pages permitting a user to change the data. In response to receipt of the changed data, program 235 may cause the processor 230 to determine and to serve to the appropriate one of the client devices 205, 206, 207 an updated illustration.

Program 235 may also provide a web front end, and be linked to back end computer systems for implementing administration of insurance accounts providing income replacement and longevity protection, as well as to back end systems for other insurance company-administered products and services. Program 235 may, by way of example, provide a user with options to update contact information and payment information, such as bank account and routing number for electronic payments, and be configured to receive a signal from user device 205, 206, 207 inputting such information, and to communicate such information to a back end system, such as system 100, so as to permit user selection of a payment information. Program 235 may be, by way of example only, a Java-based program.

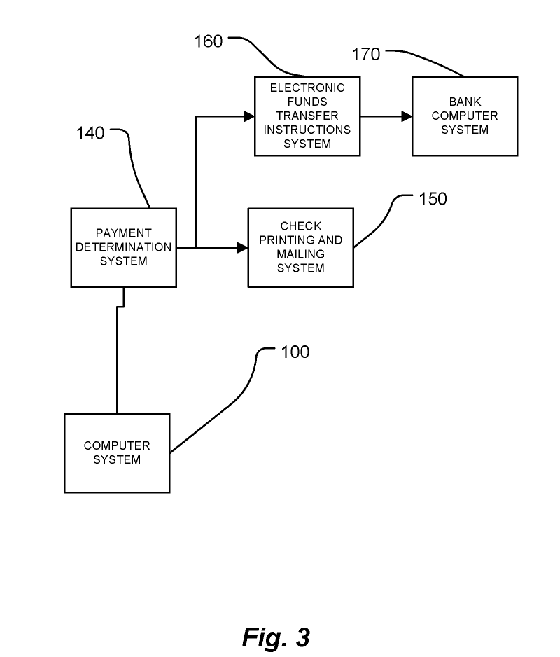

Referring now to FIG. 3, a schematic diagram showing a processor for administration of an insurance account and a payment system are shown. System 100 may communicate with payment determination system 140. Payment determination system 140 may include one or more computer systems, including processors, memory devices, user inputs, outputs, software executed by the processors, and other conventional components. Payment determination system 140 may be adapted to receive an output signal from computer system 100, such as via LAN 130 of FIG. 1 which output signal includes data indicative of payment information, such as amounts payable to a survivor's retirement account, or to a couple or a survivor of a couple, a date payable, and payment methods. Payment determination system 140 may further be adapted to determine a payor account and a payment method. The payor account may be an account with a selected bank; by way of example, payment determination system 140 may include a look-up table mapping beneficiary information, such as geographic information, to a particular bank and account. Payment determination system 140 may also include stored in memory and accessible by a processor information indicating whether a particular beneficiary or couple are to be paid by paper check, by electronic funds transfer, or by another payment method. A processor of payment determination system 140 may cause to be stored in memory of the payment determination system the determined payor account information and the determined payment method. The processor of payment determination system 140 may cause a digital signal to be output indicative of the stored payor account information, the stored payment method, amount information and payee information. Depending on the payment method information, payment determination system 140 may direct a signal to one of a number of potential recipients. The potential recipients may include payment fulfillment systems, such as check printing and mailing system 150 and electronic funds transfer instructions system 160. The payment fulfillment systems may be for receiving the digital signal from the payment determination system 140 and for fulfillment of payment in accordance with the information conveyed by the digital signal from the processor of the payment determination system 140.

In an embodiment, the payment method may be by check; given that payment method, the output digital signal from payment determination system 140 may be received by check printing and mailing system 150. Check printing and mailing system 150 may include one or more computer systems, including processors, memory devices, user inputs, outputs, software executed by the processors, and other conventional components. The outputs include in particular one or more printers, and may include other devices useful in printing and mailing paper checks, such as devices for feeding paper, separating printed checks, inserting printed checks into envelopes, sealing envelopes, and applying postage to envelopes as appropriate. Check printing and mailing system 150 may print a check drawn on a payor account in an amount and to a payee as determined by the information conveyed by the digital signal from the processor of payment determination system 140. The printed check is then mailed to the payee. The payee deposits the check in the payee's bank account, causing funds to be credited to the payee's bank account, and causing the funds to be withdrawn from the designated payor bank account from which the payment is made.

In an embodiment, the output digital signal from payment determination system 140 may be received by electronic funds transfer instructions system 160. For example, this may be the case if the payment method is by electronic funds transfer to the payee's designated account. Electronic funds transfer instructions system 160 may include one or more computer systems, including processors, memory devices, user inputs, outputs, software executed by the processors, and other conventional components. Electronic funds transfer instructions system 160 includes a processor adapted to provide an output signal indicative of an instruction to a bank determined by the payor account information to provide an electronic funds transfer from the payor account to a payee account in an amount as previously determined, such as by processor 110. The amount is the amount determined by the information conveyed by the digital signal from payment determination system 140.

The output signal from electronic funds transfer instructions system 160 may be provided to a bank computer system 170, which carries out an electronic funds transfer, debiting the designated account, and resulting in a credit to a designated payee account.

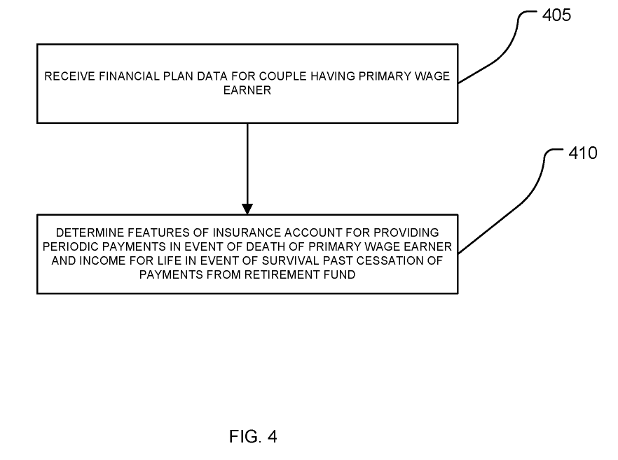

Referring now to FIG. 4, a high-level process flow of a process for providing features of an insurance account for use with a personal financial plan for a couple will be described. The process may be employed for a couple in which one member of the couple is a primary wage earner. The primary wage earner either earns all or a disproportionate share of the couple's wages. The primary wage earner is generally expected to continue to earn sufficiently high wages to contribute to the couple's savings at a far higher rate than the other. For example, the primary wage earner may be expected to remain in a relatively high paying career until retirement at an age between about 55 and 70. By way of example, the couple may be a husband and wife, and the wife may be a neurosurgeon, while the husband does not earn wages.

Exemplary features of a personal financial plan will be discussed. However, the present application will not attempt to detail all possible features of a personal financial plan. A personal financial plan prepared for a couple having a primary wage earner may include a predetermined amount that the primary wage earner contributes on a periodic basis to savings. The contributions may be on any suitable basis, such as monthly, quarterly or annually. The contributions may be to a designated account for retirement savings, such as a 401(k) account, to an account for other designated purposes, such as a 529 account for college savings, or to other types of accounts. The plan assumes that the contributions continue on the periodic basis until an assumed retirement date, which will typically be a retirement age of the primary wage earner. The retirement age of the primary wage earner may be, for example, 55, 70, or any age between those ages.

In an embodiment, income may be derived from a source other than the wages of a primary wage earner, which source would cease to pay upon the death of one of the couple. For example, one member of the couple may be entitled to receive payments from a trust for the lifetime of that member of the couple. The term primary wage earner used herein includes the receipt of income which would cease upon the death of the primary wage earner.

The financial plan may designate one or more funds into which the periodic contributions are directed. The financial plan may include assumptions regarding earnings on invested contributions. For example, a financial plan may include a single fund to provide for retirement income for the couple and another large expense, such as college tuition for the couple's child, children or grandchildren, purchase of a vacation home, an extraordinary vacation, or other expense. A financial plan may include a fund to provide for retirement income for the couple and a second fund to provide for other expenses, such as college tuition.

The financial plan may include projected withdrawals from the fund or funds to provide for income during retirement and other expenses. In the case of providing for income during retirement, the financial plan may include periodic withdrawals, such as monthly, quarterly or annually, in predetermined amounts for a period of time from the retirement age of the primary wage earner for a period of years. For example, the periodic withdrawals may be in level amounts, or may be in increasing amounts to provide for a constant standard of living assuming inflation, or may be at one level for a period of time and then drop to a lower level, to provide for greater spending during assumed good health in early retirement years and lesser spending as the couple ages and is not able to travel as much, for example. In a retirement plan, the withdrawals from the retirement fund are planned to exceed the earnings on the retirement fund, thereby gradually depleting the fund balance. For example, the financial plan may call for withdrawals for retirement income to continue for a total of 25 years after the retirement date of the primary wage earner.

Referring to FIG. 4, a computer-implemented method of determining features of an insurance plan having income replacement and longevity protection features for supplementing the financial plan of the couple will be discussed. Data relating to the financial plan is received 405 by a computer system. Data may be received in any suitable manner. For example, in a system executed in a network such as that shown in FIG. 2, processor 230 of server 220 may cause to be served to one of client devices 205, 206, 207 a form or forms that prompts the user to enter data relating to the financial plan. In an embodiment, the form may include tags in xml format that facilitate the transfer of data from client devices 205, 206, 207 to server 220. Data relating to the financial plan and received by a computer system may include the amount and timing of periodic payments to one or more funds, including at least a retirement fund, funded by the wages of the primary wage earner; investment return assumptions for the funds; current ages of the members of the couple; retirement income assumptions including the amount and timing of payments from a retirement fund, including the date of the last payment.

The processor may then determine 410 features of an insurance account for providing the periodic payments to the one or more funds, including at least a retirement fund in the event of the death of the primary wage earner, and income in the event of survival of at least one of the couple past the date of cessation of payments from the retirement fund. The features may include cost, including one or more premium amounts. The insurance account may include a term life insurance policy on the life of the primary wage earner. The term life insurance policy may continue until the retirement age of the primary wage earner under the retirement plan. The death benefit amount of the term life insurance policy may decrease as the primary wage earner's age increases. The death benefit amount of the term life insurance policy may be annuitized to provide a stream of payments equal in amount and timing to payments to the one or more funds, including the retirement fund, provided for in the retirement plan. In an embodiment, the amount of the payments from the annuitized death benefit amount may be a predetermined amount that is lower than the amount of the payments to the funds in the financial plan, on the assumption that the surviving member of the couple will be able to maintain the same standard of living in retirement with lower income than would be required had both survived. In an embodiment, the timing of the payments may be different for the same reason, e.g., the payments may cease at an earlier date than provided for in the retirement plan. In an embodiment, both the amount and the timing may be different than provided for in the retirement plan.

The insurance account further includes an annuity that commences payments upon the date of cessation of the withdrawals from the retirement fund, assuming that either of the couple are living, and continues for so long as one of them is living. The amount of the annuity payments may be greater if both are living than if only one of the couple is living. The amount of the payments may be predetermined when the insurance account is started. The amount of the payments may be level, or may be increasing. The annuity payments permit the couple, or the surviving one of the couple, to maintain a standard of living if one or both of them survives after the last payment from the retirement fund is made.

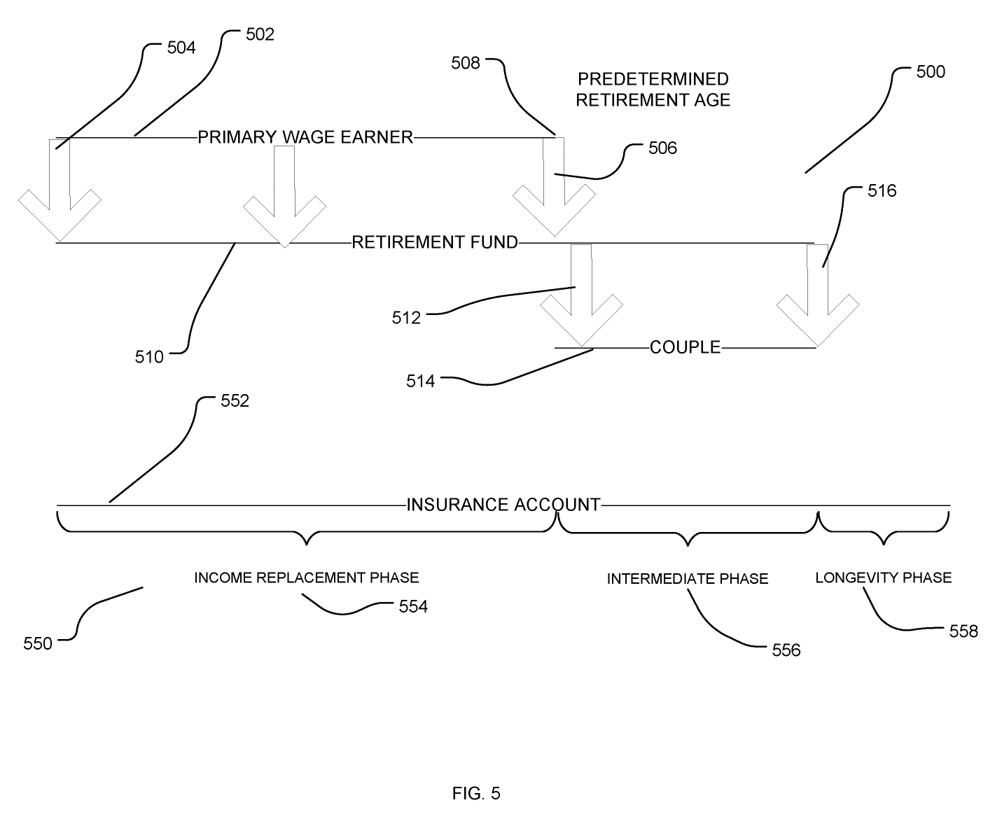

Referring now to FIG. 5, a schematic illustration of a retirement plan and an insurance account is provided. Retirement plan 500 is at the top of FIG. 5. Primary wage earner 502 provides contributions 504 to retirement fund 510, until the planned retirement age 508 of the primary wage earner. Shortly after the retirement of the primary wage earner 502, retirement fund 510 commences periodic payments 512 to the couple 514. The final payment according to the retirement plan is shown at 516. After this point, the retirement fund has no further funds.

The insurance account 552 has three phases. An income replacement phase 554 commences at the commencement of the insurance account and continues until the predetermined retirement age 508 of the primary wage earner. In the event of the death of the primary wage earner during the income replacement phase, a computer system may access data indicative of a schedule of periodic payments, including dates and amounts of payments, to the other member of the couple for a term continuing until a predetermined age of the primary wage earner, and in this example the predetermined retirement age 508.

An intermediate phase 556 commences at the end of the income replacement phase 554. During the intermediate phase 556, a computer system may access data indicative of whether the members of the couple are both living. If at any time neither of the couple is living, then the insurance account terminates. Otherwise, the account continues. The intermediate phase has the same duration as the term, according to the retirement plan, of periodic payments from retirement accounts to the couple or to the survivor of the couple.

Upon the termination of the intermediate phase 556, a longevity phase 558 commences. The longevity phase 558 may commence at the date of the last payment from the retirement funds according to the retirement plan. During the longevity phase, a processor may periodically access data indicative of whether or not either of the couple is living. If either of the couple is living, a processor may access data indicative of a schedule of periodic payments, including dates and amounts of payments, to at least one of the couple. The payments may continue periodically for a term continuing until the last to die of the couple. The payments serve the purpose of providing income to the couple after the depletion of the funds in the retirement plan.

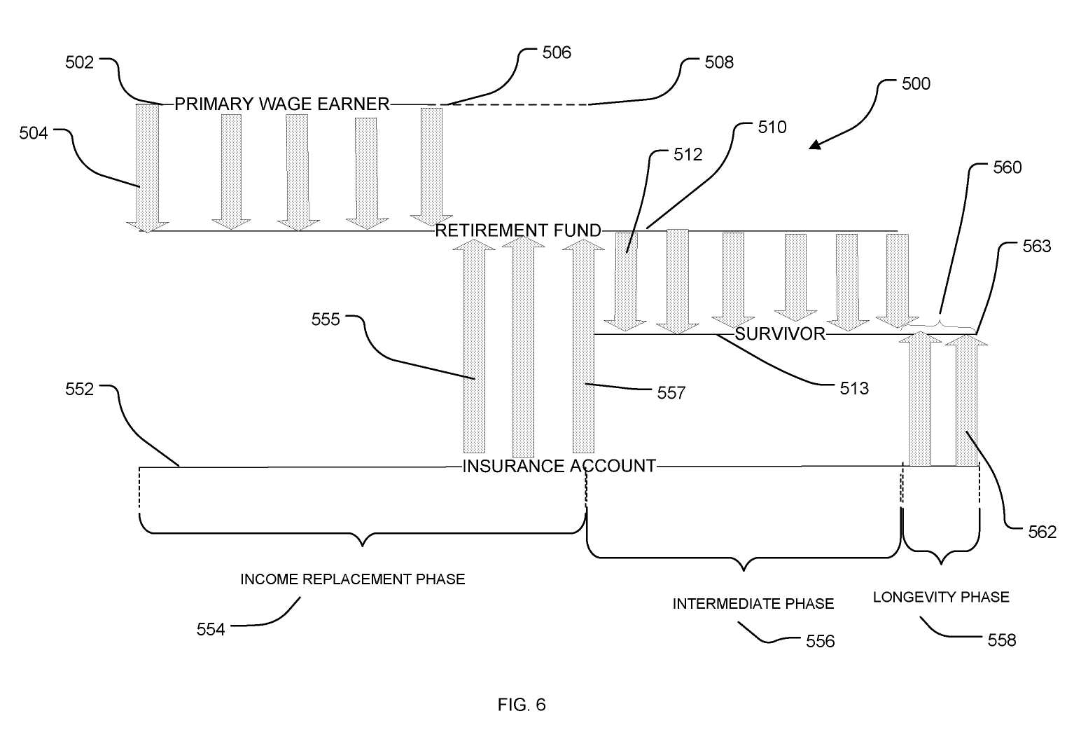

Referring now to FIG. 6, a schematic illustration of a retirement plan and an insurance account is provided, illustrating the income replacement and longevity protections of an insurance account. According to retirement plan 500, primary wage earner 502 provides contributions 504 to retirement fund 510. At a time indicated at 506, primary wage earner 502 dies, and ceases to contribute to retirement fund 510. The time 506 of death of primary wage earner 502 is during income replacement phase 554 of insurance account 552. A computer system has accessed data indicative of the death of primary wage earner 502. The computer system has accessed data indicative of a schedule of payments 555 to retirement fund 510. The payments from the insurance account 552 to retirement fund 510 continue until the planned retirement age 508 of the primary wage earner 502. In an embodiment, a single payment may be made to retirement fund 510 from insurance account 552. The single payment may represent a present value of the schedule of payments 555. Shortly after planned retirement age 508 of the primary wage earner 502, retirement fund 510 commences periodic payments 512 to the survivor 513. The periodic payments 555 have replaced payments that, according to retirement plan 500, would have been made by primary wage earner 502 to retirement fund 510. The retirement fund 510 has sufficient funds for payments to survivor 513 until the anticipated final payment 516 according to the retirement plan. After this payment, the retirement fund has no further funds.

Survivor 513 continues to live after the date of final payment 516, as indicated at 560. Longevity phase 558 of insurance account 552 commences at the date of the last payment from the retirement funds according to the retirement plan. During longevity phase 558, a processor may periodically access data indicative of whether or not the survivor is living. As the survivor continues to live, the processor accesses data indicative of a schedule of periodic payments, including dates and amounts of payments, to the survivor. The processor may provide an output signal to a payment system to effect payments 562 to survivor 513. The payments may continue periodically for a term continuing until the death of the survivor, indicated at 563lnposelendlnposelstartlnposelendlnposelstart. When the processor accesses data indicative of the death of the survivor, the payments are ceased.

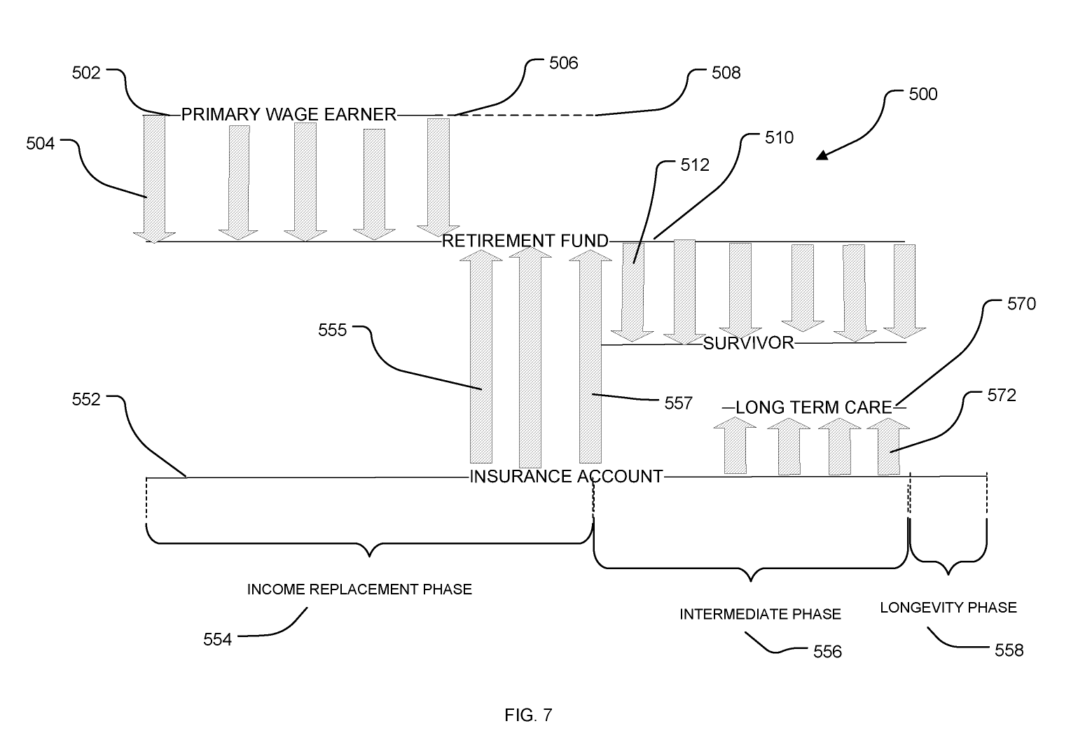

Referring to FIG. 7, a schematic illustration of a retirement plan and an insurance account is provided, illustrating an insurance account providing protection against an unexpected expense. Retirement plan 500 provides sufficient funding for retirement fund 510 for payments to cover anticipated living expenses during retirement. Insurance account 552 may include a benefit payable to the couple or the survivor of the couple in the event of a predetermined event that requires the couple or survivor to incur expenses. In an embodiment, the benefit may be payable in the event that one or both of the couple requires long-term care. Long-term care may include admission to a nursing home, assisted living facility, or other facility, for more than a minimum period of time. In the illustrated embodiment, payments are made from the insurance account during the intermediate phase 556 to long-term care 570. In an embodiment, if the insurance account is for providing a benefit payable in case of a predetermined event, a processor may periodically access data indicative of whether the predetermined event has occurred. For example, the processor may access a file in a memory storage device containing data indicative of whether one or both of the couple has been admitted to a nursing home, the duration of admission, and other data relevant to determining if conditions have been met to trigger the benefit. If the processor determines that the benefit is triggered, the processor may access data indicative of predetermined payments, including payment frequency and amount, under the insurance account. The processor may provide an output signal to a payment system having data indicative of payment amount, payment data, and payee. In an embodiment, payments may be made directly to a long-term care facility, such as a nursing home or assisted living facility, which is providing care for one or both of the couple. In an embodiment, payments may be made to the couple jointly, or to a guardian or other person handling financial matters on behalf of the couple or to the individual who requires long-term care. In an embodiment, a benefit greater in amount may be provided if both of the couple require long-term care.

The processor may continue to access data indicative of whether the conditions triggering the benefit are met. When the processor continues to determine that the conditions are met, such as one of the couple remaining admitted to a nursing home, the benefit continues. If the processor determines that the conditions are no longer met, such as by the one of the couple previously being admitted to a nursing home either dying or returning home, then the processor may output a signal indicative that the payments are to cease.

In an embodiment, a rider may be purchased such that, if both the primary wage earner and the beneficiary die during the income replacement phase, a benefit is payable to a secondary beneficiary. In this embodiment, if the processor determines during the income replacement phase that both members of the couple are deceased, the processor is adapted to access data indicative of an identify of a secondary beneficiary and an amount payable to the secondary beneficiary. The processor may provide an output signal having data indicative of the amount and the identity of the secondary beneficiary.

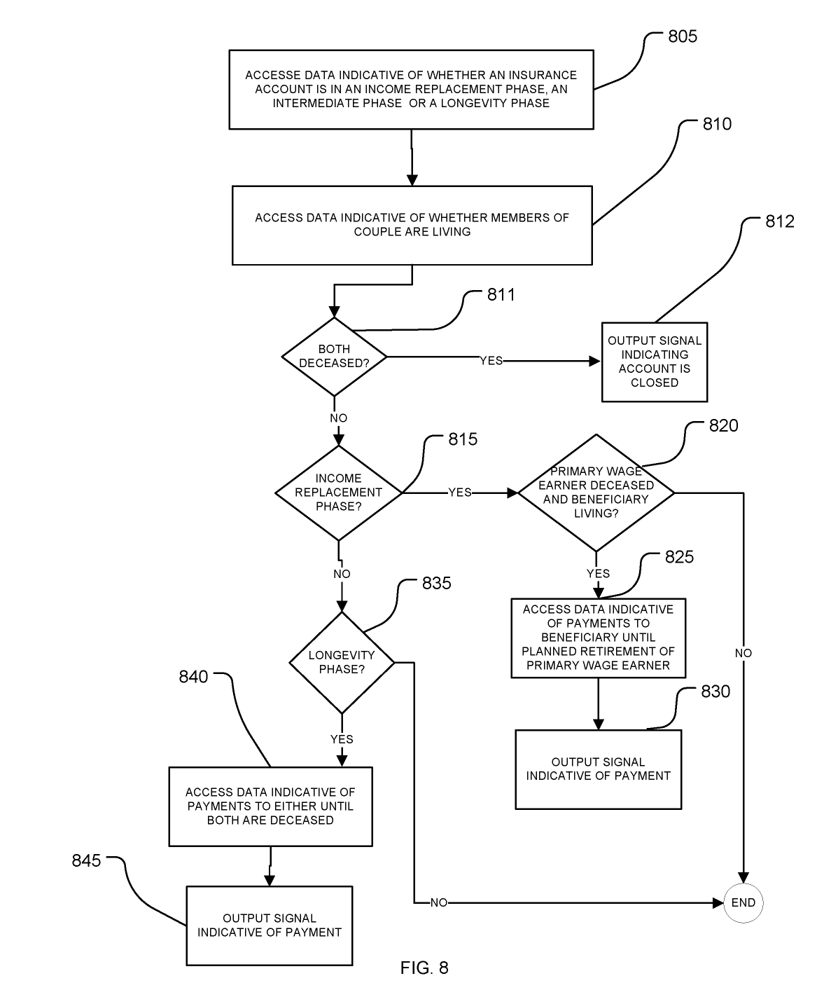

Referring to FIG. 8, a process flow of an embodiment of a method of administration of an insurance account for providing income replacement and longevity protection will be explained. A processor accesses 805 from a memory storage device data indicative of whether the account is in an income replacement phase, an intermediate phase commencing at the end of the income replacement phase, or a longevity phase commencing at the end of the intermediate phase. The processor accesses 810 from a memory storage device data indicative of whether the primary wage earner and the beneficiary are deceased. If both are deceased 811, the processor may output 812 a signal having data indicating that the account is closed. If the account is in the income replacement phase 815 and the primary wage earner is deceased and the beneficiary is living 820, the processor accesses 825 data indicative of amounts and timing of payments to the beneficiary. The processor may provide 830 an output signal having data indicative of the amount and timing of one or more of the payments to the beneficiary. If the account is in the income replacement phase and the primary wage earner is not deceased, then the process flow is at an end. If the account is 835 in the longevity phase, the processor may access 840 data indicative of a schedule of periodic payments, including dates and amounts of payments, to at least one of the primary wage earner and the beneficiary for a term continuing until the last to die of the beneficiary and the primary wage earner. The processor may provide 845 an output signal having data indicative of the amount and timing of one or more of the payments to the primary wage earner and/or the beneficiary. If the account is not in the longevity phase, i.e., in the intermediate phase, then the process flow is at an end.

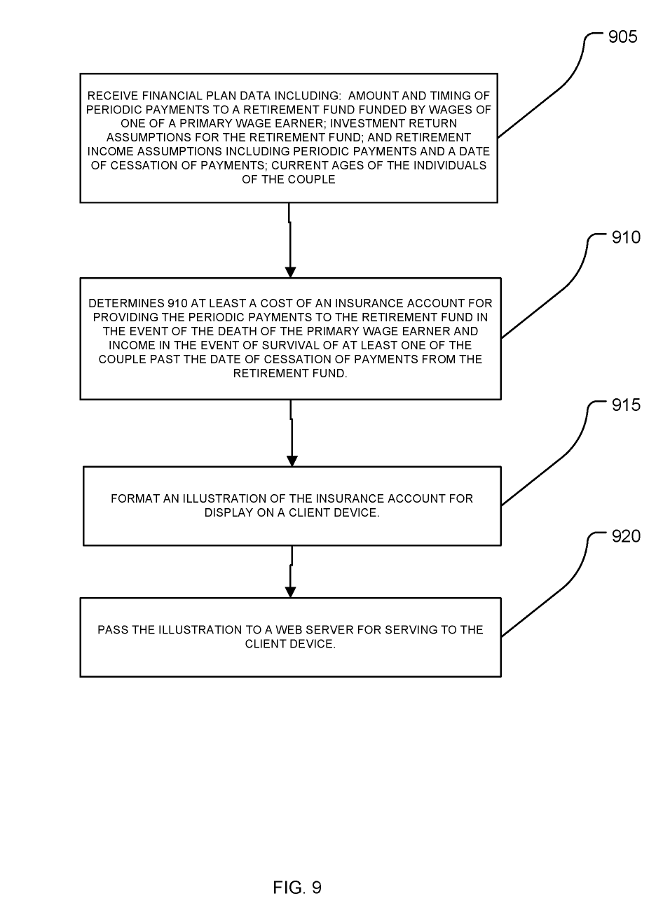

Referring to FIG. 9, a process flow of an embodiment of a method for determining features and pricing of an insurance plan having income replacement and longevity protection features for supplementing a financial plan for retirement income for a couple having a primary wage earner is illustrated. A processor receives 905 data relating to the financial plan, the data including: amount and timing of periodic payments to a retirement fund funded by wages of one of the primary wage earner; investment return assumptions for the retirement fund; and retirement income assumptions including periodic payments and a date of cessation of payments; current ages of the individuals of the couple; and separate contributions of the individuals of the couple to the retirement account. The processor determines 910 at least a cost of an insurance account for providing the periodic payments to the retirement fund in the event of the death of the primary wage earner and income in the event of survival of at least one of the couple past the date of cessation of payments from the retirement fund. The processor may format 915 an illustration of the insurance account for display on a client device. The illustration may be solely in alphanumeric format or may include one or more graphical elements. The processor may pass 920 the illustration to a web server for serving to the client device.

In an embodiment, an illustration capability may be provided that incorporates changes in a retirement plan resulting from differences in contributions or investment returns from initial assumptions. In an embodiment, a processor may access data indicative of retirement plan data updated to include actual contributions, investment returns, current balance data a retirement savings account, projected retirement savings balance data at retirement and during retirement in view of the current actual data, and anticipated payments during retirement. The anticipated payments during retirement may provide for a depletion of the retirement account at an earlier date than anticipated in an original retirement plan, because of contributions or investment returns being less than anticipated. The processor may provide a document comparing the anticipated payments and terms of the insurance account pertaining to payments during the longevity phase. For example, the document may indicate that there is an anticipated excessive duration between the last payment from the retirement account and the first payment during the longevity phase. The document may indicate that there is an overlap between the last payment from the retirement account and the first payment during the longevity phase. The information may be used by the couple or the survivor as appropriate to change the retirement plan, for example.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented, referring to FIG. 1, by processor 110 executing instructions contained in programs which may be stored in a storage medium, such as memory device 120, and loaded into random access memory for execution. It will be appreciated that any of the steps in the methods in accordance with the invention described herein may be so implemented.

An exemplary advantage of a system and method in accordance with an embodiment is that an account providing both income replacement in the event of the death of a wage earner prior to retirement and supplemental income if the wage earner outlives retirement funding is likely less expensive than separate accounts providing income replacement and supplemental income, as the same individual cannot both die prior to retirement and outlive the couple's savings.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering an insurance account for providing income replacement and longevity insurance for a couple having a primary wage earner and a beneficiary, comprising:
a processor;
a memory storage device in communication with the processor;
the processor adapted to:
access data indicative of whether the account is in an income replacement phase, an intermediate phase commencing at the end of the income replacement phase, or a longevity phase commencing at the end of the income replacement phase;
access data indicative of whether the primary wage earner and the beneficiary are living;
if the account is in any of the phases and both the primary wage earner and the beneficiary are deceased, output a signal having data indicative that the account is closed;
if the account is in the income replacement phase and the primary wage earner is deceased and the beneficiary is living, access data indicative of a schedule of periodic payments, including dates and amounts of payments, to the beneficiary for a term continuing until a predetermined age of the primary wage earner, and output a signal indicative of at least the date and amount of one of the payments;
if the account is in the intermediate phase and either or both of the primary wage earner and the beneficiary are living, output a signal indicative that the insurance account is to be maintained without change;
if the account is in the longevity phase, and either or both of the primary wage earner and the beneficiary are living, access data indicative of a schedule of periodic payments, including dates and amounts of payments, to at least one of the primary wage earner and the beneficiary for a term continuing until the last to die of the beneficiary and the primary wage earner, and output a signal indicative of at least the date and amount of one of the payments

2. The system of claim 1, wherein the data accessed indicative of periodic payments to be made during the income replacement phase includes data indicative that payments are to be made to a retirement account of the beneficiary.

3. The system of claim 1, wherein, if both the primary wage earner and the beneficiary are deceased during the income replacement phase, the processor is adapted to access data indicative of an identify of a secondary beneficiary and an amount payable to the secondary beneficiary.

4. A computer system for administering an insurance account for providing income replacement and longevity insurance for a primary wage earner and a beneficiary, comprising:
a processor; and
a memory storage device in communication with the processor;
the processor adapted to:
access data indicative of whether the account is in an income replacement phase, an intermediate phase commencing at the end of the income replacement phase, or a longevity phase commencing at the end of the intermediate phase;
access data indicative of whether the primary wage earner and the beneficiary are deceased;
if the account is in any of the phases and both the primary wage earner and the beneficiary are deceased, output a signal having data indicative that the account is closed;
if the primary wage earner is deceased and the beneficiary is not deceased, and the account is in the income replacement phase, access data indicative of one or more payments to the beneficiary, and output a signal having data indicative of the one or more payments to the beneficiary;
if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

5. The system of claim 4, wherein the data indicative of one or more payments to the beneficiary is indicative of a single payment to the beneficiary.

6. The system of claim 4, wherein the data indicative of one or more payments to the beneficiary is indicative of periodic payments to the beneficiary continuing for a term ending at a predetermined age of the primary wage earner.

7. The system of claim 6, wherein the income replacement phase ends at the predetermined age of the primary wage earner.

8. The system of claim 4, wherein the longevity phase commences a predetermined period of years after the end of the income replacement phase.

9. The system of claim 4, wherein the processor is further adapted to access data indicative of whether the primary wage earner is disabled, and if the primary wage earner is disabled during the income replacement phase, to access data indicative of a schedule of periodic payments, including dates and amounts of payments, to at least one of the primary wage earner and the beneficiary for a term continuing until the primary wage earner is no longer disabled or the expiration of the income replacement phase.

10. The system of claim 4, further comprising a web server, the web server adapted to, in response to a request from a client device, access and serve for display on the client device data pertaining to a financial plan of the primary wage earner and the beneficiary, the financial plan data comprising contribution data, retirement savings current balance data, retirement savings projected balance data, and retirement income data, simultaneously with data pertaining to the insurance account.

11. The system of claim 4, further comprising:
a payment determination system having a processor for: receiving one of the output signals, determining a payor account and a payment method; storing the determined payor account information and the determined payment method in a memory of the payment determination system; outputting of a digital signal indicative of the stored payor account information, the stored payment method, amount information and payee information; and
a payment fulfillment system for receiving the digital signal from the payment determination system and for fulfillment of payment in accordance with the information conveyed by the digital signal from the processor of the payment determination system.

12. The system of claim 11, wherein the payment fulfillment system is a check printing and mailing system for printing and mailing a check drawn on the payor account in an amount and to a payee as determined by the information conveyed by the digital signal from the processor of the payment determination system.

13. The system of claim 11, wherein the payment fulfillment system is a system for generating electronic funds transfer instructions for providing of an instruction to a bank determined by the payor account information to provide an electronic funds transfer from the payor account to a payee account in an amount determined by the information conveyed by the digital signal from the processor of the payment determination system.

14. A computer system for determining an insurance plan having income replacement and longevity protection features for supplementing a financial plan for retirement income for a couple having one primary wage earner, comprising:
a processor;
a memory device in communication with the processor;
the processor adapted to:
receive data relating to the financial plan, said data including: amount and timing of periodic payments to a retirement fund funded by wages of the primary wage earner; investment return assumptions for the retirement fund; retirement income assumptions including periodic payments and a date of cessation of payments; and current ages of the couple;
determine at least a cost of an insurance account for providing the periodic payments to the retirement fund in the event of the death of one of the couple and income in the event of survival of at least one of the couple past the date of cessation of payments.

15. The system of claim 14, wherein the processor is adapted to determine at least a cost of the insurance account, the insurance account being further for providing funds upon occurrence of a predetermined event requiring one or both of the couple to incur expenses.

16. The system of claim 15, wherein the predetermined event is admission of one or both of the couple to a care facility for a long term.

17. The system of claim 14, wherein the processor is adapted to prompt a user to provide a retirement income periodic payment amount for use in determining benefits in the event of the death of one of the couple.

18. A computer-implemented method for administering an insurance account for providing income replacement and longevity insurance for a primary wage earner and a beneficiary, comprising:
accessing by a processor from a memory storage device data indicative of whether the account is in an income replacement phase, an intermediate phase commencing at the end of the income replacement phase, or a longevity phase commencing at the end of the intermediate phase;
accessing by the processor from a memory storage device data indicative of whether the primary wage earner and the beneficiary are deceased;
if the primary wage earner is deceased and the beneficiary is not deceased, and the account is in the income replacement phase, accessing by the processor data indicative of amounts and timing of payments to the beneficiary;
providing by the processor an output signal having data indicative of the payments to the beneficiary;
if the account is in the longevity phase, and either of the primary wage earner or the beneficiary are not deceased, accessing by the processor data indicative of a schedule of periodic payments, including dates and amounts of payments, to at least one of the primary wage earner and the beneficiary for a term continuing until the last to die of the beneficiary and the primary wage earner.

19. The method of claim 18, wherein the data indicative of the payments to the beneficiary is indicative of periodic payments to the beneficiary continuing for a term ending at a predetermined age of the primary wage earner.

20. The method of claim 18, wherein the income replacement phase ends at the predetermined age of the primary wage earner.

21. The method of claim 18, further comprising accessing by the processor data indicative of whether one or both of the primary wage earner and the beneficiary is eligible to receive long term care benefits, accessing by the processor data indicative of the amount and timing of long term care benefit payments, and providing by the processor an output signal having data indicative of the amount and timing of at least one of the long term care benefit payments.

22. The method of claim 18, further comprising accessing by the processor data indicative of whether the primary wage earner is disabled, and if the primary wage earner is disabled during the income replacement phase, accessing by the processor data indicative of a schedule of periodic payments, including dates and amounts of payments, to at least one of the primary wage earner and the beneficiary for a term continuing until the primary wage earner is no longer disabled or the expiration of the income replacement phase.

23. A method for determining features of an insurance plan having income replacement and longevity protection features for supplementing a financial plan for retirement income for a couple having a primary wage earner, comprising:
receiving by the processor data relating to the financial plan, said data including: amount and timing of periodic payments to a retirement fund funded by wages of the primary wage earner; investment return assumptions for the retirement fund; retirement income assumptions including periodic payments and a date of cessation of payments; and current ages of the couple;
determining by the processor at least a cost of an insurance account for providing the periodic payments to the retirement fund in the event of the death of one of the couple and income in the event of survival of at least one of the couple past the date of cessation of payments.

24. The method of claim 23, further comprising formatting by the processor for display an illustration of the insurance account featuring premium costs and insurance account benefits.

25. The method of claim 24, further comprising prompting a user to provide modifications to the received data relating to the financial plan in association with display of the illustration.

26. A computer-readable medium having a plurality of instructions thereon which, when executed by a processor, cause the processor to:
access data indicative of whether the account is in an income replacement phase, an intermediate phase commencing at the end of the income replacement phase, or a longevity phase commencing at the end of the intermediate phase;
access data indicative of whether the primary wage earner and the beneficiary are deceased;
if the account is in any of the phases and both the primary wage earner and the beneficiary are deceased, output a signal having data indicative that the account is closed;
if the primary wage earner is deceased and the beneficiary is not deceased, and the account is in the income replacement phase, access data indicative of one or more payments to the beneficiary, and output a signal having data indicative of the one or more payments to the beneficiary;
if the account is in the longevity phase, and either of the primary wage earner or the beneficiary are not deceased, access data indicative of a schedule of periodic payments, including dates and amounts of payments, to at least one of the primary wage earner and the beneficiary for a term continuing until the last to die of the beneficiary and the primary wage earner.

27. The computer-readable medium of claim 26, wherein said instructions further cause the processor to:
access data indicative of retirement plan data updated to include actual contributions, investment returns and anticipated payments during retirement; and
provide a document comparing the anticipated payments during retirement and terms of the insurance account pertaining to payments during the longevity phase.

28. The computer-readable medium of claim 27, wherein the document comprises a graphical presentation.
